(19) United States
(12) Patent Application Publication
(10) Pub. No.: US 2016/0259405 A1
(43) Pub. Date: Sep. 8, 2016

(54) Eye Gaze for Automatic Paging

(71) Applicant: Microsoft Technology Licensing, LLC, Redmond, WA (US)

(72) Inventors: Andrew D. Wilson, Seattle, WA (US); Shane F. Williams, Seattle, WA (US)

(21) Appl. No.: 14/636,291

(22) Filed: Mar. 3, 2015

(51) Int. Cl. G06F 3/01; G06F 3/0483

(52) U.S. Cl. CPC G06F 3/013; G06F 3/012; G06F 3/0483

(57) ABSTRACT

Leveraging eye gaze and/or other user interactions for automatic paging on a display of a user device is described. In at least one example, the techniques describe receiving input from one or more tracking components. The input may indicate that a gaze of a user is detected on a display associated with a user device. The techniques may further describe determining that the gaze of the user has moved from a first region of at least two regions of the display to a second region of the at least two regions of the display. Based at least in part on determining that the gaze of the user has moved from the first region to the second region, the techniques herein describe updating a portion of the content in the first region of the display via one or more transitions.

### BACKGROUND

Eye gaze may be considered a proxy for a user's attention. Accordingly, observing eye movements via tracking components may provide insight into the cognitive processes in the brain. With the increase of computerized devices, humans have more opportunities to interact with displays associated with computerized devices. Current interaction techniques may determine where on a display of a computerized device a user is looking. Moreover, eye gaze data collected from the tracking components may be used to control various aspects of the display.

### SUMMARY

Techniques described herein leverage eye gaze and/or other user interactions for automatic paging on user devices. Using eye gaze and/or other user interactions to modify content on a display of a user device enables users to interact with user devices without manually (e.g., by hand, physical interaction, etc.) interacting with the user devices. That is, users may manipulate content on displays of user devices without using their hands or other input devices. Unlike current techniques, the techniques described herein avoid problems related to imprecise eye tracking and consequential unpredictable scrolling behavior. Furthermore, the techniques described herein enable the use of less accurate or less precise tracking components and accordingly, reduce consumption of computational resources.

In at least one example, the techniques describe receiving input from one or more tracking components. The input may indicate that a gaze of a user is detected on a first region of at least two regions of a display associated with a user device. The techniques may further describe determining that the gaze of the user has moved from the first region to a second region of the at least two regions of the display. Based at least in part on determining that the gaze of the user has moved from the first region of the display to the second region of the display, the techniques herein describe updating a portion of the content in the first region of the display. The update may be performed without distracting the user, or without causing the gaze of the user to shift back to the first region of the display or to shift away from the display.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### DESCRIPTION OF FIGURES

The Detailed Description is described with reference to the accompanying figures. In the figures, the left-most digit(s) of a reference number identifies the figure in which the reference number first appears. The same reference numbers in different figures indicate similar or identical items.

FIG. 1 illustrates an example environment for leveraging eye gaze for automatic paging.

FIG. 2 illustrates an example operating environment that includes a variety of devices and components that may be implemented for leveraging eye gaze for automatic paging.

FIG. 3 illustrates an example operating environment that may be implemented for leveraging eye gaze for automatic paging.

FIG. 4 illustrates an example process for updating a portion of content presented on a display.

FIG. 5 illustrates an example process for updating a portion of content presented on a display.

FIG. 6 illustrates an example process for updating a portion of content presented on a display.

FIG. 7 illustrates an example process for updating a portion of content presented on a display.

FIG. 8 illustrates an example process for updating a portion of content presented on a display.

FIG. 9 illustrates an example process for updating a portion of content presented on a display when a user looks away from the display.

### DETAILED DESCRIPTION

Techniques described herein leverage eye gaze and/or other user interactions for automatic paging on user devices. Using eye gaze and/or other user interactions to modify content on a display of a user device enables users to interact with user devices without manually (e.g., by hand, physical interaction, etc.) interacting with the user devices. That is, users may manipulate content on displays of user devices without using their hands or other input devices (e.g., stylus, mouse, etc.). Unlike current techniques, the techniques described herein avoid problems related to imprecise eye tracking and consequential unpredictable scrolling behavior. The techniques described herein require less tracking precision than current techniques and exploit a phenomenon known as “change blindness” to mitigate user distractions when manipulating content on a display. Furthermore, the techniques described herein enable the use of less accurate or less precise tracking components and accordingly, reduce consumption of computational resources.

As described above, eye gaze may be considered a proxy for a user's attention. Current techniques may determine where on a display of a user device a user is looking. Moreover, eye gaze data collected from tracking components may be used to control various aspects of the display. As an example, some techniques use eye gaze data to enable users to directly interact with user devices. In particular, other techniques leverage dwell times associated with eye gaze to ascertain which items on a display a user intends to interact with. Further techniques enable eye gestures and/or other movements (e.g., blink of an eye) to signal selection of an item or object on a display.

In some examples, interpreting eye movements on a display of a user device may enable detection of reading and/or viewing behavior. A system may leverage eye gaze to determine where a person is currently reading and/or viewing content (e.g., text, images, videos, etc.) on a display of a user device and may automatically scroll the content when the user approaches the bottom of the display. As the user approaches the bottom of the display, previously unseen text, images, and/or videos may be presented on the display scrolling from the bottom of the display with previously seen content scrolling to the top of the display. However, such techniques may lead to an unpredictable scrolling motion due to imprecise or noisy eye tracking. Additionally or alternatively, difficulties in determining when a user is at a bottom of a display may lead to a jarring or distracting scrolling motion on the display. As a result, such techniques for interacting with computerized devices using eye gaze may lead to an unpleasant user experience. Additionally, current techniques require precise and accurate tracking components that consume a significant amount of computational resources and/or are expensive to incorporate into user devices.

The techniques herein describe systems and methods for leveraging eye gaze and/or other user interaction to enable users to move through content without requiring manual paging by the users. The techniques described herein exploit a phenomenon known as “change blindness.” Change blindness describes an occurrence wherein a user who is focusing on a region of a display does not notice changes to a different region of the display where the user is not looking because he or she is focusing on the other region. Change blindness enables smooth transitions between content presented on the display that prevent drawing the eye of the user away from the region of the display that he or she is focusing on.

In at least one example, the techniques herein describe receiving input from one or more tracking components. The input may indicate that a gaze of a user is detected on a first region of at least two regions of a display associated with a user device. The techniques may further describe determining that the gaze of the user moved from the first region to a second region of the at least two regions of the display. Based at least in part on determining that the gaze of the user moved from the first region of the display to the second region of the display, the techniques herein describe updating a portion of the content in the first region of the display. As the user reads and/or views the content in the second region of the display, the techniques described herein may update the content in the first region of the display so that as the user finishes reading and/or viewing content in the second region of the display and returns to the first region of the display, the user may read and/or view previously unseen content. The previously unseen content presented in the first portion of the display may be successive and/or serial to the content the user previously read and/or viewed in the second region of the display.

The techniques may further describe determining the gaze of the user moved from the second region of the display back to the first region of the display, or to another region of the display. Based at least in part on determining that the gaze of the user moved from the second region of the display to the first region of the display, the techniques herein describe automatically updating a portion of the content in the second region of the display. As the user reads and/or views the content in the first region of the display, the techniques described herein may update the content in the second region of the display so that as the user finishes reading and/or viewing content in the first region of the display and continues into the second region of the display, the user may read and/or view previously unseen content. The previously unseen content presented in the second portion of the display may be successive and/or serial to the content the user previously read and/or viewed in the first region of the display. These inputs and updates may repeat such that as a user reads and/or views the content from top to bottom (or left to right) and returns to the top (or left), the content continuously advances without distracting the user, or otherwise causing the gaze of the user to leave the region of the display that he or she is currently focusing on and/or interacting with (e.g., the gaze shifting to a different region of the display, away from the display, etc.). Leveraging the techniques herein provides a user with an experience as though he or she is reading and/or viewing a never ending book or image collection.

In a non-limiting example, as a user reads an electronic book (eBook) from top to bottom, content associated with successive pages may transition onto a region of the display while the user reads the text in a different region of the display. In an additional or alternative example, as a user views a collection of images from top to bottom of the display, additional images from the collection may transition onto a region of the display while the user views images in a different region of the display. As a result, the user may engage in natural or reflexive behavior of reading text and/or viewing images and/or videos left to right and top to bottom, returning to a starting position (e.g., top left corner, left edge, etc.), and may receive new content without manually interacting with the user device.

### Illustrative Environment

The environments described below constitute but one example and are not intended to limit application of the system described below to any one particular operating environment. Other environments may be used without departing from the spirit and scope of the claimed subject matter. The various types of processing described herein may be implemented in any number of environments including, but not limited to, stand-alone computing systems, network environments (e.g., local area networks or wide area networks), peer-to-peer network environments, distributed-computing (e.g., cloud-computing) environments, etc.

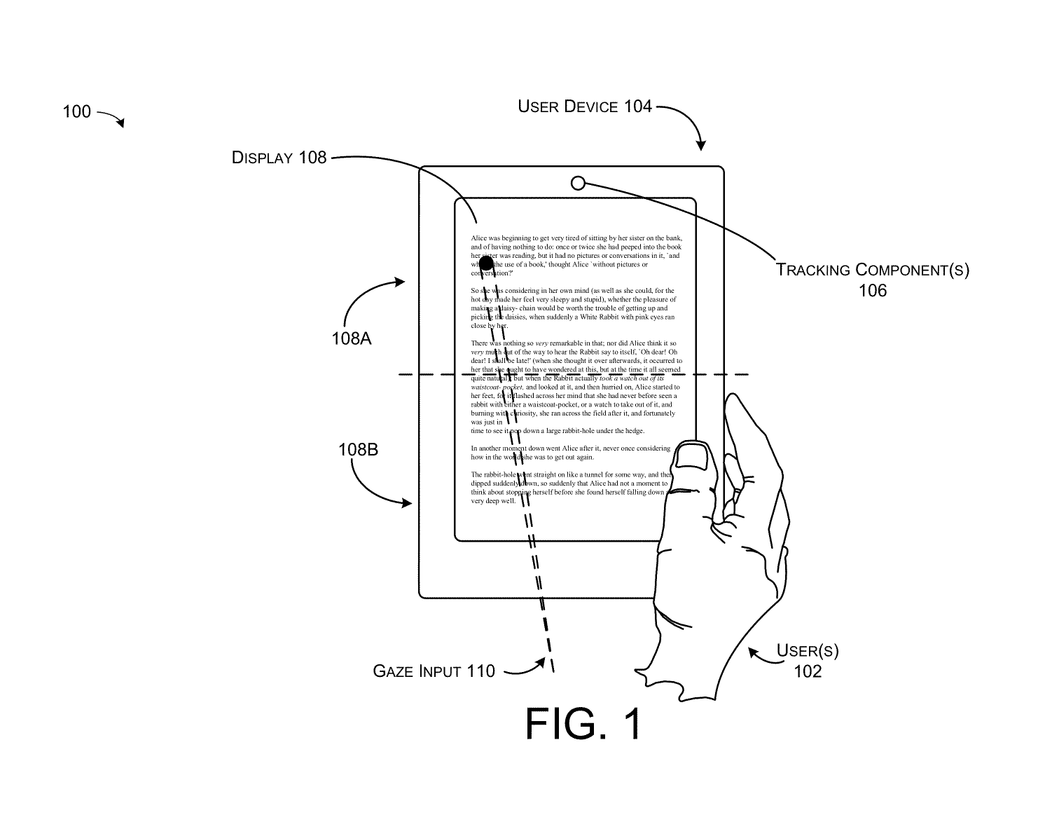

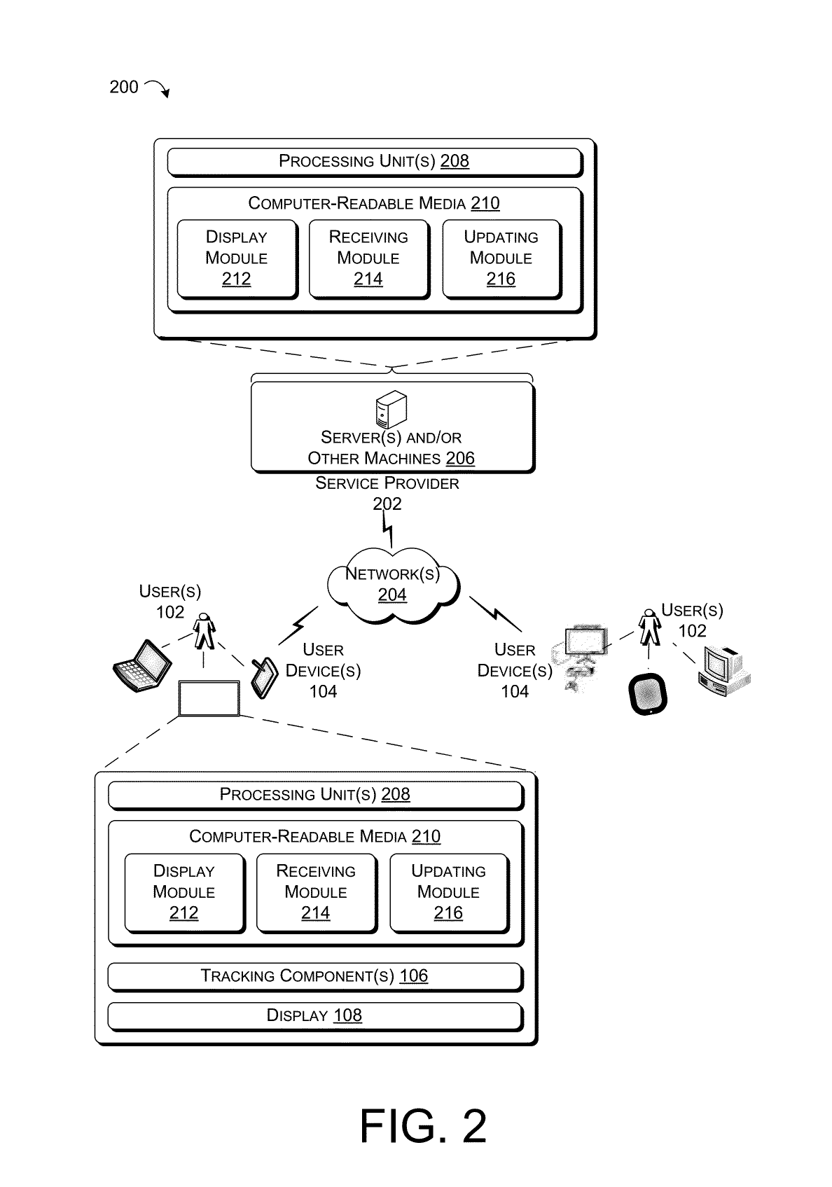

FIG. 1 illustrates an example environment 100 for leveraging eye gaze for automatic paging. Environment 100 includes one or more user(s) 102 that interact with one or more user device(s) 104. The one or more user device(s) 104 may comprise, for example, a desktop computer, laptop computer, smartphone, wearable device, videogame console, television, or any of the user device(s) 104 described below with respect to FIG. 2. In at least one example, the user device(s) 104 may include user device(s) 104 with displays 108 that update at a rate below a predetermined threshold, such as e-ink displays (e.g., Kindle, Nook, etc.). The one or more user device(s) 104 may be in communication with one or more tracking component(s) 106 and, in at least some examples, a display 108. In at least one example, the one or more tracking component(s) 106 and/or display 108 may be integrated into the one or more user device(s) 104. In other examples, the one or more tracking component(s) 106 and/or display 108 may be separate devices connected to or in communication with the one or more user device(s) 104. In FIG. 1, a tracking component of the one or more tracking component(s) 106 and the display 108 are integrated into a user device 104.

The one or more tracking component(s) 106 may include any sensor, camera, device, system, etc. that may be used for tracking eye gaze, head pose, body movement, etc. In at least one example, the one or more tracking component(s) 106 track the user's 102 eye gaze saccades, fixations, etc. A saccade describes quick, simultaneous movements of both eyes between two phases of fixation the same direction. A fixation describes a dwell time on a particular region of a display 108. In some examples, the one or more tracking component(s) 106 may track the user's 102 head pose and/or a direction a user's nose points as a proxy for gaze saccades, fixations, etc., as described below.

The one or more tracking component(s) 106 may comprise Tobii Rex eye tracking systems, SensoMotoric Instruments (SMI) eye tracking systems, Sentry eye tracking systems, Microsoft Kinect® technology, etc. In at least one example, the one or more tracking component(s) 106 may leverage gaze sensing techniques such as those designed to detect when a user 102 is looking directly at a camera, employing alternative on-axis and off-axis infrared illuminant and image processing, etc. In some examples, one or more cameras and/or sensors may be placed around a bezel of a user device 104 to determine when a user 102 is focusing in a region of the display 108 and/or has reached a certain position in content that may be presented on the display 108. The precision and/or accuracy of the one or more tracking components(s) 106 may be below a predetermined threshold such that the one or more tracking component(s) 106 may minimally be required to determine which region of two or more regions of the display a user 102 interacts with.

In at least one example, the display 108 may represent a user interface and the user interface may present content to a user 102. The display 108 may present electronic content representative of pages in an electronic book (eBook), content associated with a webpage, etc. In at least some examples, the content may include text, images, videos, etc. In additional or alternative examples, the content may be arranged serially such that when a user 102 reads and/or views the content, the user 102 reads and/or views the content in a left to right and top to bottom progression.

The display 108 may be divided into two or more regions. In at least one example, the display 108 may be divided into a top region 108A and a bottom region 108B, as illustrated in FIG. 1. The bottom region 108B may be adjacent to the top region 108A and below the top region 108A. In other examples, the display 108 may be divided into a left region and a right region that is adjacent to the left region and to the right of the left region, a top region, middle region, and bottom region, a plurality of regions arranged in circular, rectangular, abstract shapes, etc. While the display 108 may be divided into two or more regions, the display 108 may appear to the one or more user(s) 102 as a single display. That is, the one or more user(s) 102 may not be able to tell that the display is divided 108 into regions.

The one or more user(s) 102 may interact with the user device 104 via various modes of communication, such as gaze, gestures, facial expressions, etc. User input may include one or more of gaze input 110, gesture input, etc. In some examples, two or more user(s) 102 may interact with the user device 104 simultaneously. Gaze may represent a position of a user's eyes on the display 108 of the user device 104. The one or more tracking component(s) 106 may track user gaze to generate gaze input 110. Gaze input 110 may include eye gaze input, head pose input, and/or nose pointing input. Head pose input may include a configuration in which a user's 102 head poses during user interaction with the user device 104. Nose pointing may include a direction a user's 102 nose points during user interaction with the user device 104. Head pose input and nose pointing input may each serve as proxies for eye gaze input. The alternative and/or additional facial orientation characteristics (e.g., head pose and/or nose pointing) may be used depending on the range of the one or more tracking component(s) 106 and/or the size of the display 108. In at least one example, the one or more tracking component(s) 106 may be within a predetermined distance from the user's 102 face and/or a size of the display 108 may be below a predetermined threshold (e.g., display on a wearable, smartphone, etc.) and accordingly, the one or more tracking component(s) 106 may track user 102 eye gaze for the gaze input 110. In an alternative example, the tracking component may be beyond a predetermined distance from the user's 102 face and/or a size of the display 108 may be above a predetermined threshold (e.g., display on a television, projection screen, etc.) and, as a result, the one or more tracking component(s) 106 may track head pose or nose pointing as a proxy for user 102 gaze.

The one or more tracking component(s) 106 may track movement of a user's 102 eyes (or head, nose, etc.) to generate gaze input 110 for the user 102. In at least one example, the one or more tracking component(s) 106 may determine a specific location on the display 108 where a gaze input 110 is directed to, and then, the one or more tracking component(s) 106 may interact with one or more components stored on the user device 104 to make a determination as to which region of the display 108 the gaze input 110 corresponds. The one or more tracking component(s) 106 continue to track the gaze input 110 in order to determine whether the gaze input 110 is moving, and whether the gaze input 110 has shifted to a different region of the display 108.

Based at least in part on the gaze input 110, the system 104 may replace content on the display with previously unseen content. In at least some examples, the system 104 may replace content on the display 108 at substantially the same time or within a threshold time after the system 104 detects movement of a user's 102 eye gaze. In other examples, the system 104 may detect movement of the user's 102 eye gaze but may wait to replace the content based at least in part on one or more parameters (e.g., reading or viewing classifiers, dwell engines, etc.). The one or more parameters may be used to eliminate false positives, or eye movement that may falsely trigger an update of content on the display 108. In at least one example, as the one or more tracking component(s) 106 track the user's 102 eyes from a top region 108A of the display 108 to the bottom region of the display 108B, the system may replace the content in the top region 108A with previously unseen content. As the one or more tracking component(s) 106 track the user's eyes from the bottom region 108B to the top region 108A, the system may replace the content in the bottom region 108B with previously unseen content. This pattern may be repeated such that the user 102 simply reads from top to bottom of a display and is continuously presented previously unseen content. The content may include pages from an e-Book, images from an image collection, etc. The previously unseen content may include successive pages in the e-Book, new images in the image collection, etc.

FIG. 2 illustrates an example operating environment 200 that includes a variety of devices and components that may be implemented for leveraging eye gaze for automatic paging. In at least one example, the techniques described herein may be performed remotely (e.g., by a server, cloud, etc.). In some examples, the techniques described herein may be performed locally on a computing device, as described below. More particularly, the example operating environment 200 may include a service provider 202, one or more network(s) 204, one or more user(s) 102, and one or more user device(s) 104 associated with the one or more users 102, as described in FIG. 1.

As shown, the service provider 202 may include one or more server(s) and other machines 206 and/or the one or more user device(s) 104, any of which may include one or more processing unit(s) 208 and computer-readable media 210. In various examples, the service provider 202 may enable users 102 to automatically page through text and/or view content on the display 108 without manually interacting with a user device 104.

In some examples, the network(s) 204 may be any type of network known in the art, such as the Internet. Moreover, the one or more user device(s) 104 may communicatively couple to the network(s) 204 in any manner, such as by a global or local wired or wireless connection (e.g., local area network (LAN), intranet, etc.). The network(s) 204 may facilitate communication between the server(s) and other machines 206 and/or the one or more user device(s) 104 associated with the one or more user(s) 102.

In some examples, the one or more user(s) 102 may interact with the corresponding user device(s) 104 to perform various functions associated with the one or more user device(s) 104, which may include one or more processing unit(s) 208, computer-readable media 210, one or more tracking component(s) 106, and display 108.

The one or more user device(s) 104 may represent a diverse variety of device types and are not limited to any particular type of device. Examples of user device(s) 104 may include but are not limited to stationary computers, mobile computers, embedded computers, or combinations thereof. Example stationary computers may include desktop computers, work stations, personal computers, thin clients, terminals, game consoles, personal video recorders (PVRs), set-top boxes, or the like. Example mobile computers may include laptop computers, tablet computers, wearable computers, implanted computing devices, telecommunication devices, automotive computers, personal data assistants (PDAs), portable gaming devices, media players, cameras, e-readers, or the like. Example embedded computers may include network enabled televisions, integrated components for inclusion in a computing device, appliances, microcontrollers, digital signal processors, or any other sort of processing device, or the like.

The service provider 202 may be any entity, server(s), platform, etc., that may facilitate automatic paging based at least in part on tracking eye gaze. Moreover, and as shown, the service provider 202 may include one or more server(s) and/or other machines 206, which may include one or more processing unit(s) 208 and computer-readable media 210 such as memory. The one or more server(s) and/or other machines 206 may include devices, as described below.

Examples support scenarios where device(s) that may be included in the one or more server(s) and/or other machines 206 may include one or more computing devices that operate in a cluster or other grouped configuration to share resources, balance load, increase performance, provide fail-over support or redundancy, or for other purposes. Device(s) included in the one or more server(s) and/or other machines 206 may belong to a variety of categories or classes of devices such as traditional server-type devices, desktop computer-type devices, mobile devices, special purpose-type devices, embedded-type devices, and/or wearable-type devices. Thus, although illustrated as desktop computers, device(s) may include a diverse variety of device types and are not limited to a particular type of device. Device(s) included in the one or more server(s) and/or other machines 206 may represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) that may be included in the one or more server(s) and/or other machines 206 may include any type of computing device having one or more processing unit(s) 208 operably connected to computer-readable media 210 such as via a bus, which in some instances may include one or more of a system bus, a data bus, an address bus, a PCI bus, a Mini-PCI bus, and any variety of local, peripheral, and/or independent buses. Executable instructions stored on computer-readable media 210 may include, for example, a display module 212, a receiving module 214, an update module 216, and other modules, programs, or applications that are loadable and executable by processing units(s) 208. Alternatively, or in addition, the functionality described herein may be performed, at least in part, by one or more hardware logic components such as accelerators. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator may represent a hybrid device, such as one from ZYLEX or ALTERA that includes a CPU course embedded in an FPGA fabric.

Device(s) that may be included in the one or more server(s) and/or other machines 206 may further include one or more input/output (I/O) interface(s) coupled to the bus to allow device(s) to communicate with other devices such as user input peripheral devices (e.g., a keyboard, a mouse, a pen, a game controller, a voice input device, a touch input device, gestural input device, eye and/or body tracking device and the like) and/or output peripheral devices (e.g., a display, a printer, audio speakers, a haptic output, and the like). The one or more input/output (I/O) interface(s) may allow user device(s) 104 to communicate with the one or more tracking component(s) 106 and/or the display 108. Devices that may be included in the one or more server(s) and/or other machines 206 may also include one or more network interfaces coupled to the bus to enable communications between computing device and other networked devices such as the one or more user device(s) 104. Such network interface(s) may include one or more network interface controllers (NICs) or other types of transceiver devices to send and receive communications over a network. For simplicity, some components are omitted from the illustrated device.

User device(s) 104 may further include one or more input/output (I/O) interface(s) coupled to the bus to allow user device(s) 104 to communicate with other devices such as user input peripheral devices (e.g., a keyboard, a mouse, a pen, a game controller, a voice input device, a touch input device, gestural input device, eye and/or body tracking device and the like) and/or output peripheral devices (e.g., a display, a printer, audio speakers, a haptic output, and the like). The one or more input/output (I/O) interface(s) may allow user device(s) 104 to communicate with the one or more tracking component(s) 106 and/or the display 108.

Processing unit(s) 208 and may represent, for example, a central processing unit (CPU)-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that may be used include Application-Specific Integrated Circuits (ASICs), Application-Specific Standard Products (ASSPs), System-on-a-chip systems (SOCs), Complex Programmable Logic Devices (CPLDs), etc. In various examples, the processing unit(s) 208 may execute one or more modules and/or processes to cause the one or more user device(s) 104 to perform a variety of functions, as set forth above and explained in further detail in the following disclosure. Additionally, each of the processing unit(s) 208 may possess its own local memory, which also may store program modules, program data, and/or one or more operating systems.

In at least one example, the computer-readable media 210 in the one or more user device(s) 104 may include components that facilitate interaction between user device(s) 104 and the user(s) 102. For instance, the computer-readable media 210 may include at least the display module 212, receiving module 214, and updating module 216 that may be implemented as computer-readable instructions, various data structures, and so forth via at least one processing unit(s) 208 to configure a device to replace content on a region of a display 108 with previously unseen content.

In at least one example, the display module 212 may be configured to communicate with the display 108 and cause content (e.g., text, images, videos, etc.) to be rendered on the display 108. As described above, the display 108 may represent a user interface and the display module 212 may communicate with the display 108 to present the content to a user 102 in a user interface associated with a web browser, eBook, etc. In at least one example, the receiving module 214 may be configured to receive input from the one or more user(s) 102 such as gestures, gaze input 110, body positioning, etc., as described below, and determine a position associated with the input from the one or more user(s) 102. The updating module 216 may be configured to determine when to update a region of the display 108 and, based at least in part on determining to update a region of the display 108, the updating module 216 may send previously unseen content to the display module 212 for causing the content to be presented on the display 108.

Depending on the exact configuration and type of the user device(s) 104 and or servers and/or other machines 206, computer-readable media 210 may include computer storage media and/or communication media. Computer storage media may include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that may be used to store and maintain information for access by a computing device.

In contrast, communication media may embody computer readable instructions, data structures, program modules, or other data in a modulated data signal, such as a carrier wave, or other transmission mechanism. As defined herein, computer storage media does not include communication media.

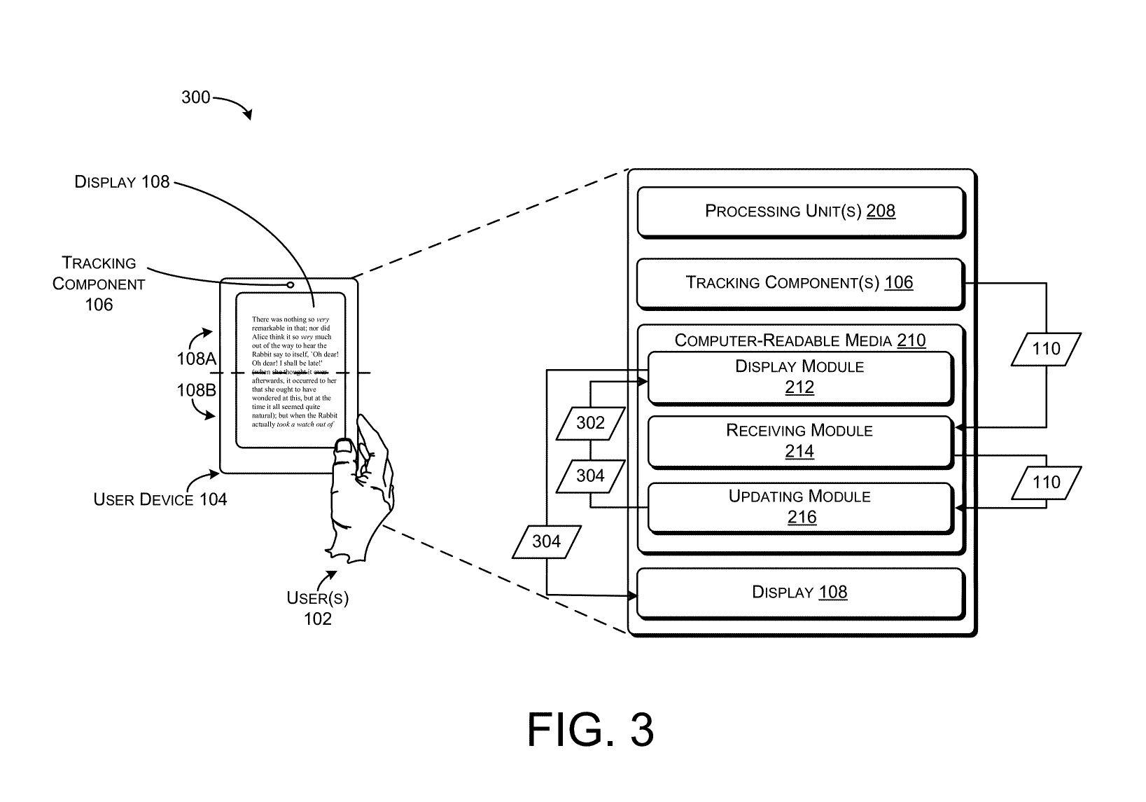

FIG. 3 illustrates an example operating environment 300 that may be implemented for leveraging eye gaze for automatic paging. In FIG. 3, the one or more tracking component(s) 106 may detect and track user interaction with a display 108. In at least one example, the one or more tracking component(s) 106 may determine a specific location on the display 108 where user interaction is directed to, and then, the one or more tracking component(s) 106 may interact with the receiving module 214 and/or the updating module 216 to make a determination as to which region of the display 108 the user interaction corresponds. The one or more tracking component(s) 106 continue to track the gaze input 110 in order to determine whether the gaze input 110 is moving, and whether the gaze input 110 has shifted to a different region.

The receiving module 214 may receive gaze input 110 via the one or more tracking component(s) 106. The gaze input 110 may indicate that the one or more tracking component(s) 106 has detected user interaction on the display 108 and may provide tracking information indicating how a user's 102 eye gaze fixations interact with the display 108. The receiving module 214 may leverage the gaze input 110 to determine a position of the user interaction with the display 108. For example, the receiving module 214 may determine whether the user interaction is associated with a first region (e.g., top region 108A) of the display 108 or a second region (e.g., bottom region 108B) of the display 108, etc. The receiving module 214 may also determine that the user interaction has moved from the first region (e.g., top region 108A) to a second region (e.g., bottom region 108B) and/or from the second region to a third region, etc. In at least one example, the second region may represent a middle region and the user interaction may move from a middle region to a bottom region (e.g., bottom region 108B), etc. The receiving module 214 may send the gaze input 110, including the determinations of the position of the user interaction with the display 108 to the updating module 216. Based at least in part on receiving the position of the user interaction on the display 108, the updating module 216 may send updating data 302 and content 304 to the display module 212.

The updating data 302 may include directions as to which region of the display 108 to update. In at least one example, the updating data 302 may direct the display module 212 to update the content 304 in the region of the display 108 not associated with the user interaction (e.g., region of the display 108 where the user is not looking, etc.). The content 304 may include content 304 for the update. In at least one example, the content 304 may include previously unseen content, as described above. The display module 212 may cause the previously unseen content to be presented on the display 108 in the region of the display 108 indicated by the updating data 302.

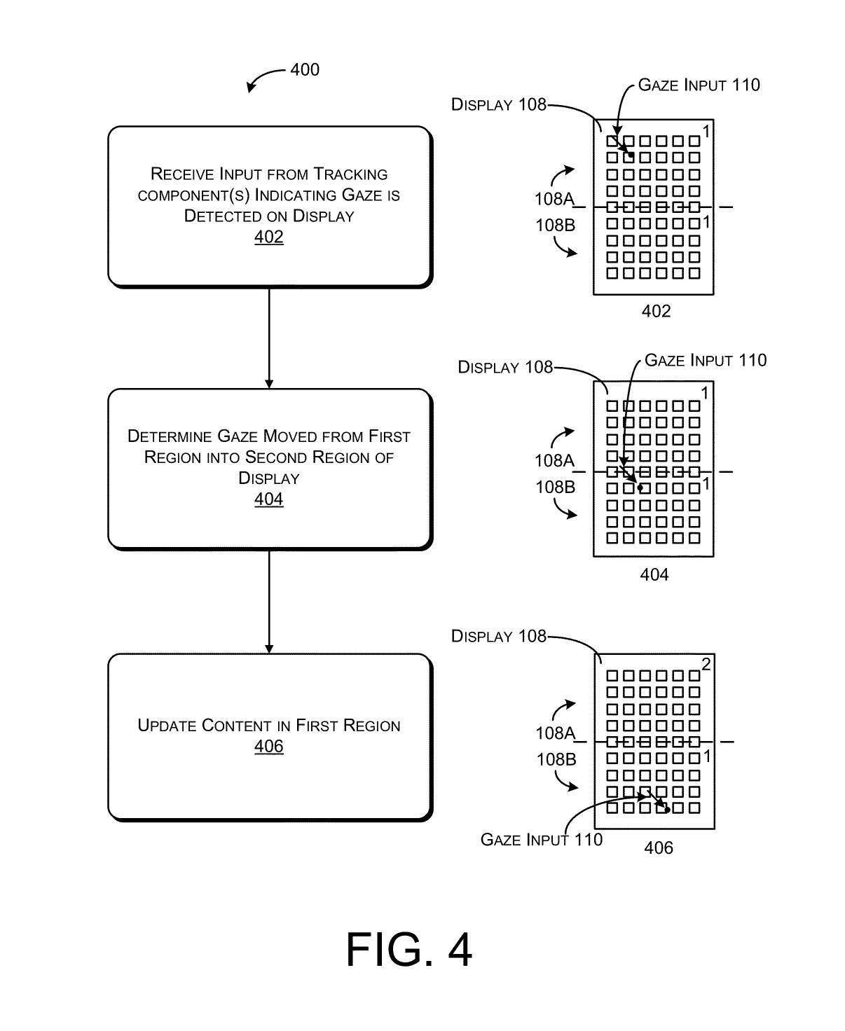

FIG. 4 illustrates an example process 400 for updating a portion of content presented on a display 108 of a user device 104. Each block has a corresponding diagram shown to the right of the block.

Block 402 illustrates receiving input from one or more tracking component(s) 106 indicating that a gaze of a user 102 is detected on a display 108. As described above, nose position or head position may also be used in addition or alternatively to user gaze to detect and/or determine a position of user interaction on a display 108. The one or more tracking component(s) 106 may track a gaze of a user 102 on the display 108 leveraging one or more sensors, cameras, devices, systems, etc. that may be used for tracking eye gaze, head pose, body movement, etc. In at least one example, the one or more tracking component(s) 106 may leverage gaze sensing techniques such as those designed to detect when a user is looking directly at a camera, employing alternative on-axis and off-axis infrared illuminant and image processing, etc., as described above. The one or more tracking component(s) 106 may send gaze input 110 to the receiving module 214. The receiving module 214 may determine a position of the gaze of the user 102 on the display 108. As described above, the display 108 may have two or more regions and accordingly, the receiving module 214 may determine which region of the two or more regions the user interaction is directed to (e.g., which region the user is looking at). For instance, the receiving module 214 may determine that the gaze of the user 102 is associated with a first region of at least two regions of the display 108.

The diagram 402 corresponding to Block 402 illustrates the gaze input 110 in the first region 108A of the display 108. In the non-limiting example of FIG. 4, the display 108 is presenting a plurality of images associated with a first page of images, as indicated by the number “1” in the upper-right hand corner of the top region 108A and the bottom region 108B.

Block 404 illustrates determining that the gaze of the user 102 moved from the first region 108A into a second region 108B of the at least two regions of the display 108. Based at least in part on the gaze input 110, the receiving module 214 may determine that a gaze of a user 102 moved from the first region 108A to the second region 108B of at least two regions of a display 108. The diagram 404 corresponding to Block 404 illustrates the gaze input 110 moving from the first region 108A of the display 108 to the second region 108B of the display 108.

In at least some examples, the receiving module 214 may determine that the gaze of the user 102 is detected in the second region 108B (i.e., that the user gaze moved from the first region 108A to the second region 108B) based at least in part on one or more parameters. The one or more parameters may be used to eliminate false positives, or eye movement that may falsely trigger an update of content on the display 108. The one or more parameters may include reading or viewing classifiers, dwell engines, etc. In at least one example, a reading classifier may detect patterns in the user eye movement (e.g., saccades, fixations, etc.) indicative of a user 102 reading words arranged in lines of text. Additionally or alternatively, a reading classifier may detect patterns in the user eye movement (e.g., saccades, fixations, etc.) indicative of a user 102 returning to a margin or predetermined position on a page. Viewing classifiers may detect patterns in the user 102 eye movement (e.g., saccades, fixations, etc.) indicative of a user 102 scrolling through or viewing images arranged in a predetermined configuration. Dwell engines may determine an amount of time the user's 102 eye movement is associated with a particular region of the display 108 and if the determined amount of time is above a predetermined threshold, the dwell engine may determine the gaze of the user 102 is detected in the second region 102B. The receiving module 214 may leverage the one or more parameters to reduce falsely triggered content updates due to a user 102 randomly scanning the display 108. The one or more parameters may also aid with controlling the speed and timing of automatic paging.

Block 406 illustrates updating a portion of the content in the first region 108A of the display 108. Based at least in part on determining that the gaze of the user 102 moved from the first region 108A to the second region 108B, the updating module 216 may send updating data 302 and content 304 to the display module 212. The updating data 302 may direct the display module 212 to update content in the first region 108A of the display. The content 304 may include previously unseen content that the display module 212 may cause to be presented in the first region 108A of the display 108. In at least one example, the display module 212 may cause the content presented in the first region 108A of the display 108 to be replaced by previously unseen content without distracting the user 102. That is, the display module 212 may cause the content presented in the first region 108A of the display 108 to be replaced by previously unseen content without causing the gaze of the user 102 to shift back to the first region 108A of the display 108, and without causing the gaze of the user 102 to shift in other directions, such as away from the display 108. The display module 212 may exploit change blindness so that the user 102 (who is focusing on the second region 108B of the display 108) does not notice changes to the first region 108A of the display 108. Change blindness enables smooth transitions between content presented on the display 108 such to prevent drawing the eye of the user 102 away from the region of the display 108 that he or she is focusing on.

The display module 212 may automatically update the content in the first region 108A with previously unseen content using one or more transitions. The one or more transitions may include cross-fading the content with the previously unseen content. Cross-fading includes dissolving or gradually transitioning from a first piece of content to a second piece of content. In a cross-fading example where the cross-fade is performed line by line, the transition may appear as more of a wipe than a cross-fade as the previously unseen content replaces the previously read content line by line. A wipe, or sweep, describes replacing a first piece of content with a second piece of content by a transition that appears to travel from a first region of the display 108 to a second region of the display 108 or in a predetermined shape. The one or more transitions may further include morphing the content into the previously unseen content or sweeping away the content and replacing it with the previously unseen content. Morphing describes gradually reshaping a first piece of content to become another piece of content. Other transitions may also be used to update content on the display 108 with new, previously unseen content so long as the transitions are smooth such not to distract the user 106. The one or more transitions may vary depending on the content being updated by the display module 212. For instance, if the content includes text, a cross-fade may be more appropriate than a morph. However, if the content includes images, a morph may be more appropriate than a cross-fade. In at least some examples, text, images, and/or videos may be standardized into a particular format with respect to font, size, alignment, hue, brightness, location on the display 108, etc. to minimize any distractions to the users 102 and effectuate subtle changes to regions of the display 108 where the user 102 is not looking and/or interacting with the display 108.

The diagram 406 corresponding to Block 406 illustrates the gaze input 110 in the second region 108B of the display 108. Additionally, the diagram 406 illustrates that the content previously associated with the first page of images, as indicated by the number “1” in the upper-right hand corner of the top region 108A, has been replaced with a previously unseen page of images, as indicated by the number “2” in the upper-right hand corner of the top region 108A. However, the bottom region 108B of the display 108 continues to display images associated with the first page of images, as indicated by the number “1” in the upper-right hand corner of the bottom region 108B. While the gaze of the user 102 is focused in the bottom region 108B of the display 108, the display module 212 caused previously unseen content to be presented in place of the content in the top region 108A of the display 108 without distracting the user 102. Accordingly, when the user 102 is ready to move on to viewing new images, the user 102 instinctively looks to the top of the display 108. When the user 102 looks to the top of the display 108, previously unseen content (e.g., new images) may be presented and the user 102 may have no knowledge of the transition.

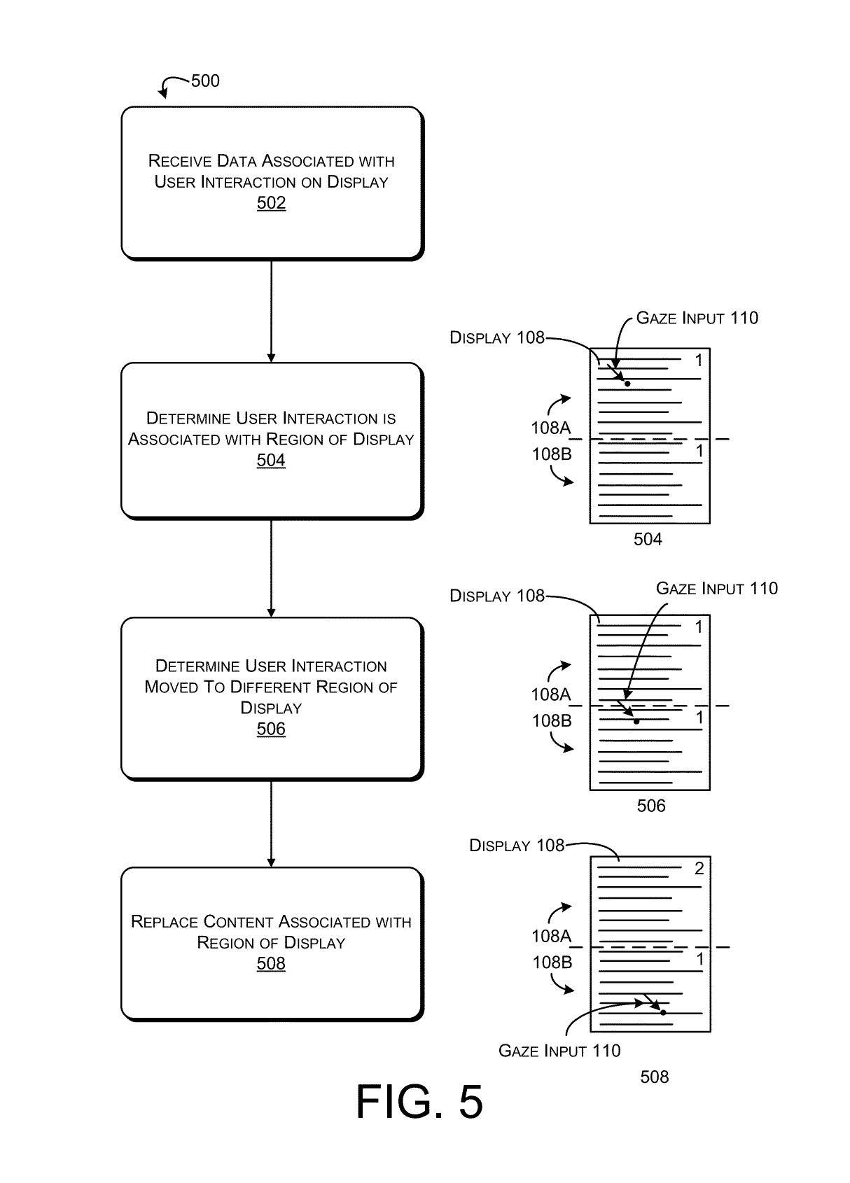

FIG. 5 illustrates an example process 500 for replacing a portion of content presented on a display 108. Blocks 504-508 have corresponding diagrams shown to the right of the blocks.

Block 502 illustrates receiving, from one or more tracking device(s) 106, data indicating user interaction on a display 108 of a user device 104. As described above, one or more tracking device(s) 106 may be used to track eye gaze, nose position, and/or or head position to detect user interaction on a display 108. The one or more tracking component(s) 106 may send gaze input 110 to the receiving module 214. In at least one example, the gaze input 110 may include tracking data for determining a position of the user interaction on the display 108.

Block 504 illustrates determining that the user interaction is associated with a region of the display 108. The receiving module 214 may determine a position of the user interaction on the display 108. As described above, the display 108 may have two or more regions and accordingly, the receiving module 214 may determine which region of the two or more regions the user interaction is directed to (e.g., which region the user is looking at). Based at least in part on the gaze input 110 and/or tracking data, the receiving module 214 may determine that the user interaction is directed to a specific region of the display 108. In at least some examples, the specific region may be the top region 108A, the bottom region 108B, a left region, a right region, etc. The diagram 504 corresponding to Block 504 illustrates the user interaction (e.g., gaze input 110) in a specific region (e.g., top region 108A) of the display 108. In the non-limiting example of FIG. 5, the display 108 is presenting text associated with a first page of text (e.g., e-Book, webpage, etc.), as indicated by the number “1” in the upper-right hand corner of the top region 108A and the bottom region 108B.

Block 506 illustrates determining that the user interaction moved to a different region of the display 108. Based at least in part on the gaze input 110 and/or tracking data, the receiving module 214 may determine that the user interaction moves from a specific region of the display 108 to a different region of the display 108. In at least some examples, specific region may be the top region 108A and the different region may be the bottom region 108B of the display. In other examples, the different region may be the top region 108A, a middle region, a left region, right region, etc. In at least some examples, the receiving module 214 may determine that the user interaction is detected in the different region 108B based at least in part on one or more parameters (e.g., dwell engines, reading and/or viewing classifiers, etc.), described above. The one or more parameters may be used to eliminate false positives, or eye movement that may falsely trigger a replacement of content on the display 108. The diagram 506 corresponding to Block 506 illustrates the user interaction (e.g., gaze input 110) moving from a region of the display 108 (e.g., the first region 108A) to a different region (e.g., the second region 108B) of the display 108.

Block 508 illustrates replacing content associated with the region of the display 108. Based at least in part on determining that the user interaction moved from the region (e.g., the first region 108A) to a different region (e.g., the second region 108B), the updating module 216 may send updating data 302 and content 304 to the display module 212. The updating data 302 may direct the display module 212 to update content in the region of the display 108 lacking user interaction (e.g., the region of the display 108 where the user 102 is not looking). The content 304 may include previously unseen content that the display module 212 may cause to be presented in the region of the display 108. In at least one example, the display module 212 may cause the content presented in the region of the display 108 to be replaced by previously unseen content without distracting the user 102. The content may be replaced by the previously unseen content via one or more transitions (e.g., cross-fading, morphing, sweeping, etc.), as described above. As described above, the display module 212 may exploit change blindness so that the user 102 (who is focusing on the different region of the display 108) does not notice changes to other regions of the display 108.

The diagram 508 corresponding to Block 508 illustrates the user interaction (e.g., gaze input 110) in the different region (e.g., bottom region 108B) of the display 108. Additionally, the diagram 508 illustrates that the content previously associated with the first page of text, as indicated by the number “1” in the upper-right hand corner of the top region 108A, has been replaced with a previously unseen page of text, as indicated by the number “2” in the upper-right hand corner of the top region 108A. However, the bottom region 108B of the display 108 continues to display text associated with the first page, as indicated by the number “1” in the upper-right hand corner of the bottom region 108B. While the user interaction is focused in the different region (e.g., bottom region 108B) of the display 108, the display module 212 may cause previously unseen content to replace the content in other regions (e.g., top region 108A) of the display 108 without distracting the user 102. Accordingly, when the user 102 is ready to move on to reading a next page in an eBook or additional content on a website, the user instinctively looks to the top of the display 108. When the user 102 looks to the top of the display 108, previously unseen content (e.g., new text) may be presented and the user 102 may have no knowledge of the transition.

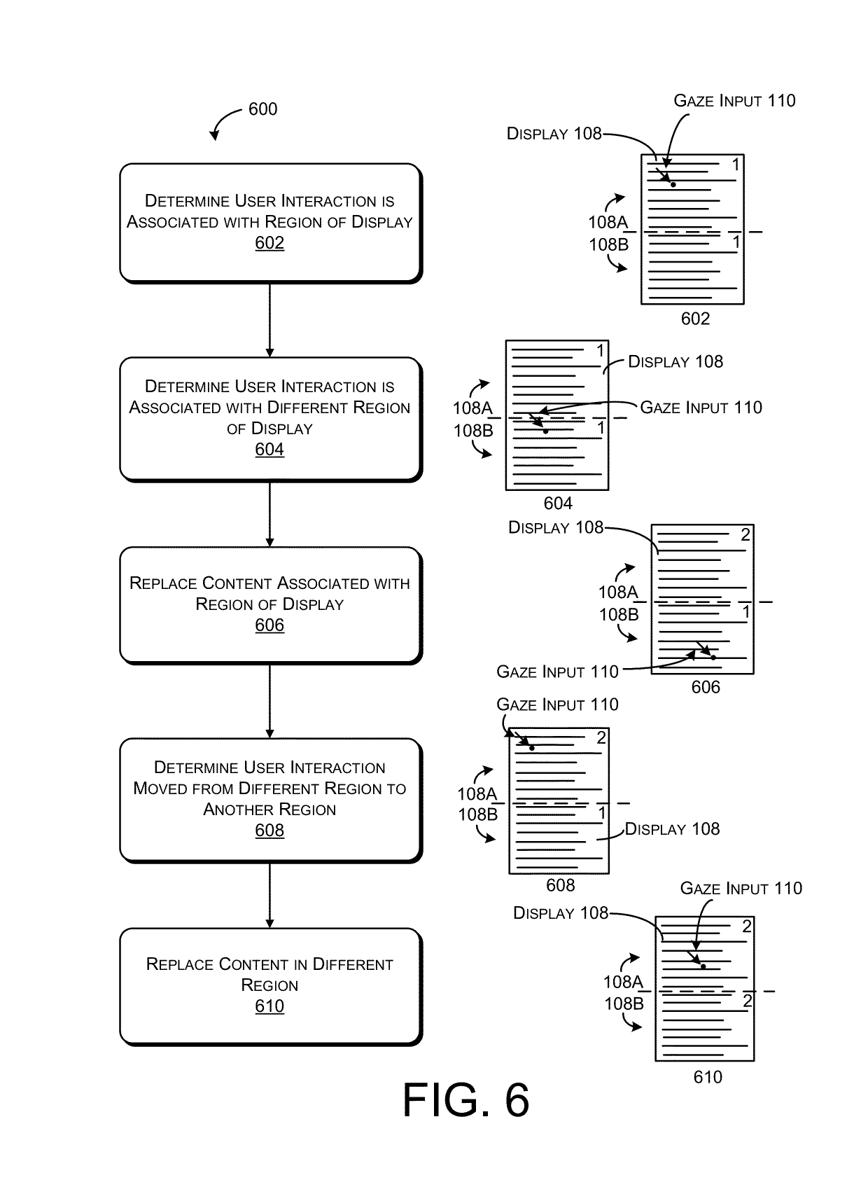

FIG. 6 illustrates an example process 600 for replacing a portion of content presented on a display 108. Each block has a corresponding diagram shown to the right of the block.

Block 602 illustrates determining that a user interaction is associated with a region of the display 108. Based at least in part on the gaze input 110 and/or tracking data, the receiving module 214 may determine that the user interaction is directed to a specific region of the display 108. In at least some examples, the specific region may be the top region 108A, middle region, the bottom region 108B, a left region, a right region, etc. The diagram 602 corresponding to Block 602 illustrates the user interaction (e.g., gaze input 110) in the specific region (e.g., top region 108A) of the display 108. In the non-limiting example of FIG. 6, the display 108 is presenting text associated with a first page of text, as indicated by the number “1” in the upper-right hand corner of both the top region 108A and the bottom region 108B. The text may be associated with an eBook, webpage, etc.

Block 604 illustrates determining that the user interaction is associated with a different region of the display 108. Based at least in part on the gaze input 110 and/or tracking data, the receiving module 214 may determine that the user interaction moves from a specific region of the display 108 to a different region of the display 108. In at least some examples, the different region may be the bottom region 108B of the display. In other examples, the different region may be the top region 108A, a middle region, a left region, right region, etc. In at least some examples, the receiving module 214 may determine that the user interaction is detected in the different region 108B based at least in part on one or more parameters (e.g., dwell engines, reading and/or viewing classifiers, etc.). The one or more parameters may be used to eliminate false positives, or eye movement that may falsely trigger a replacement of content on the display 108. The diagram 604 corresponding to Block 604 illustrates the user interaction (e.g., gaze input 110) moving from a region of the display 108 (e.g., the first region 108A) to a different region (e.g., the second region 108B) of the display 108.

Block 606 illustrates replacing content associated with the region 108A of the display 108 with previously unseen content. Based at least in part on determining that the user input moved from the region (e.g., the first region 108A) to a different region (e.g., the second region 108B), the updating module 216 may send updating data 302 and content 304 to the display module 212. The updating data 302 may direct the display module 212 to update content in the region of the display 108 lacking user interaction (e.g., the region of the display 108 where the user 102 is not looking). The content 304 may include previously unseen content that the display module 212 may cause to be presented in the region of the display 108. In at least one example, the display module 212 may cause the content presented in the region of the display 108 to be replaced by previously unseen content without distracting the user 102. The content may be replaced by the previously unseen content via one or more transitions (e.g., cross-fading, morphing, sweeping, etc.), as described above. As described above, the display module 212 may exploit change blindness so that the user 102 (who is focusing on the different region of the display 108) does not notice changes to other regions of the display 108

The diagram 606 corresponding to Block 606 illustrates the user interaction (e.g., gaze input 110) in the different region (e.g., bottom region 108B) of the display 108. Additionally, the diagram 606 illustrates that the content previously associated with the first page of text, as indicated by the number “1” in the upper-right hand corner of the top region 108A, has been replaced with a previously unseen page of text, as indicated by the number “2” in the upper-right hand corner of the top region 108A. However, the bottom region 108B of the display 108 continues to display text associated with the first page, as indicated by the number “1” in the upper-right hand corner of the bottom region 108B. While the user interaction is focused in the different region (e.g., bottom region 108B) of the display 108, the display module 212 may cause previously unseen content to replace the content in other regions (e.g., top region 108A) of the display 108 without distracting the user 102. Accordingly, when the user 102 is ready to move on to reading a next page in an eBook or additional content on a website, the user instinctively looks to the top of the display 108. When the user 102 looks to the top of the display 108, previously unseen content (e.g., new text) may be presented and the user 102 may have no knowledge of the transition.

Block 608 illustrates determining the user interaction moved from the different region to another region. In at least one example, the different region may be the bottom region 108B and the user interaction may move back to the top region 108A. In other examples, the different region may be a middle region and the user interaction may move to the bottom region 108B. Based at least in part on the gaze input 110 and/or tracking data, the receiving module 214 may determine that the user interaction moves from the different region (e.g., bottom region 108B) of the display 108 to the other region (e.g., top region 108A) of the display 108. In at least some examples, the receiving module 214 may determine that the user interaction moved to another region (e.g., top region 10A) based at least in part on one or more parameters (e.g., dwell engines, reading and/or viewing classifiers, etc.). The diagram 608 corresponding to Block 608 illustrates the user interaction (e.g., gaze input 110) moving from a different region of the display 108 (e.g., bottom region 108B) to another region (e.g., top region 108A) of the display 108. In at least one example, such user interaction may be indicative of a user automatically paging to a next page in an eBook or a new set of images in an image collection.

Block 610 illustrates replacing content associated with the different region 108B of the display 108 with previously unseen content. Based at least in part on determining that the user input moved from the different region (e.g., the bottom region 108B) to another region (e.g., the top region 108A), the updating module 216 may send updating data 302 and content 304 to the display module 212. The updating data 302 may direct the display module 212 to update content in the region of the display 108 lacking user interaction (e.g., the region of the display 108 where the user 102 is not looking). The content 304 may include previously unseen content that the display module 212 may cause to be presented in the region of the display 108. In at least one example, the display module 212 may cause the content presented in the region of the display 108 to be replaced by previously unseen content without distracting the user 102 (e.g., without causing the gaze of the user 102 to shift back to the different region of the display 108 or to shift away from the display 108). The content may be replaced by the previously unseen content via one or more transitions (e.g., cross-fading, morphing, sweeping, etc.), as described above. As described above, the display module 212 may exploit change blindness so that the user 102 (who is focusing on the different region of the display 108) does not notice changes to other regions of the display 108. In at least one example, the updating module 216 may wait a predetermined amount of time before sending the update data 302 and content 304 to the display module 212. In other examples, the updating module 216 may wait to send the update data 302 and content 304 until one or more parameters (e.g., reading classifier, viewing classifier, etc.) indicate that the user 102 is interacting with the other region (e.g., top region 108A) of the display 108. Accordingly, when a user 102 decides that he or she wants to view a few lines of text, words of text, images, etc. in the region (e.g., different region, bottom region 108B, etc.) that he or she recently finished reading, the user 102 may easily return to the portion of content he or she was previously reading.

The diagram 610 corresponding to Block 610 illustrates the user interaction (e.g., gaze input 110) in the other region (e.g., top region 108A) of the display 108. Additionally, the diagram 608 illustrates that the content previously associated with the first page of text, as indicated by the number “1” in the upper-right hand corner of the bottom region 108B, has been replaced with a previously unseen page of text, as indicated by the number “2” in the upper-right hand corner of the bottom region 108B. The top region 108A of the display 108 continues to display text associated with the second page, as indicated by the number “2” in the upper-right hand corner of the top region 108A. While the user interaction is focused in the other region (e.g., top region 108A) of the display 108, the display module 212 may cause previously unseen content to replace the content in other regions (e.g., bottom region 108B) of the display 108 without distracting the user 102. As a result, the content presented on the display 108 may be representative of a complete page of an eBook (e.g., page “2”). Accordingly, when the user 102 is ready to move on to reading the rest of the page in an eBook or additional content on a website, the user instinctively looks to the bottom of the display 108. When the user 102 looks to the bottom of the display 108, previously unseen content (e.g., new text) may be presented and the user 102 may have no knowledge of the transition.

This process may repeat such that a user 102 may read and/or view content on a display 108 from top to bottom and left to right and may automatically receive previously unseen content without manually paging through the content. The process 600 may repeat until the user 102 reaches the last page of an eBook or exhausts the content on a webpage, in a collection of images, etc. In at least one example, the receiving module 214 may repeatedly determine that the user interaction is directed to a specific region of the display 108 (e.g., the region of the display, the different region of the display, or another region of the display). Based at least in part on the repeatedly determining that the user interaction is directed to a specific region of the display 108 (e.g., the region of the display, the different region of the display, or another region of the display), the updating module 216 may send updating data 302 and content 304 to the display module 212. The updating data 302 may direct the display module 212 to update content in the region of the display 108 lacking user interaction (e.g., the region of the display 108 where the user 102 is not looking).

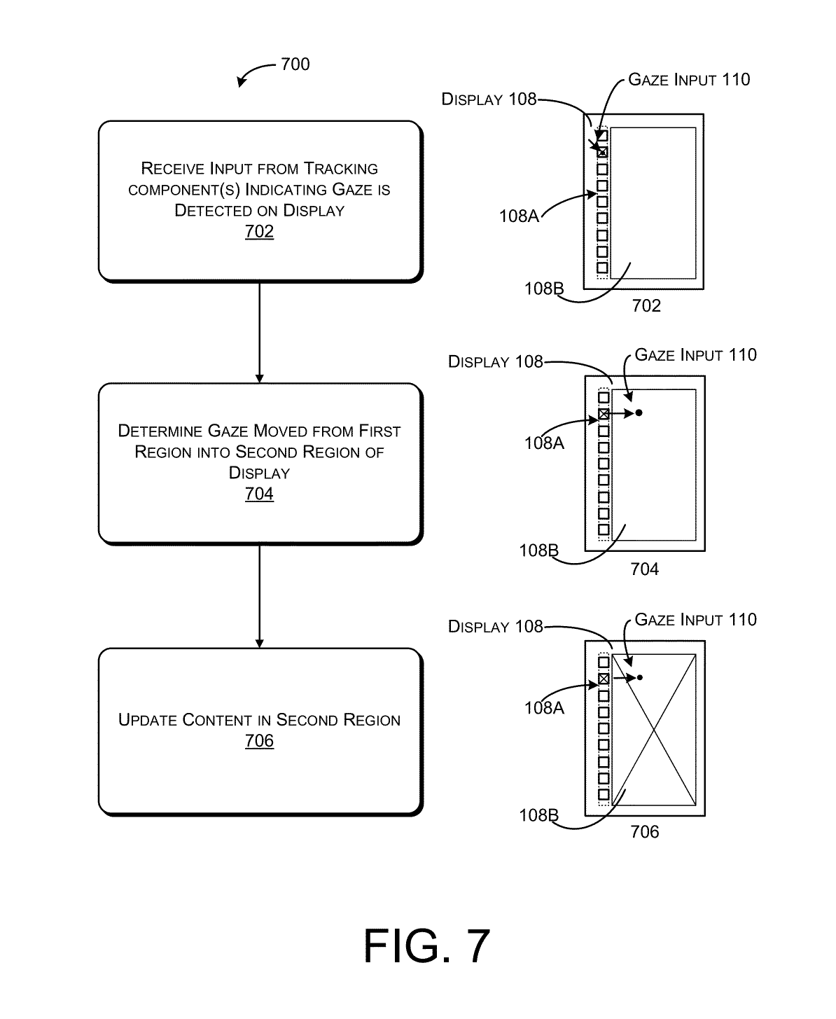

FIG. 7 illustrates an example process 700 for updating a portion of content presented on a display 108. Each block has a corresponding diagram shown to the right of the block.

Block 702 illustrates receiving input from one or more tracking component(s) 106 indicating a gaze of a user 102 is detected on a display 108, as described above. In the non-limiting example of FIG. 7, the diagram 702 corresponding to Block 702 illustrates the display 108 having a first region 108A illustrated by a dashed box around a plurality of content items and a second region 108B. The gaze input 110 in the first region 108A of the display 108 is associated with a particular content item of a plurality of content items. The particular content item is marked with an “x”.

Block 704 illustrates determining that the user gaze moved from a first region 108A of at least two regions of a display 108 into a second region 108B of the at least two regions of the display 108. That is, the user gaze may terminate in the second region 108B of the display 108. Based at least in part on the gaze input 110, the receiving module 214 may determine that a gaze of a user 102 moved from the first region 108A to the second region 108B of at least two regions of a display 108. In at least some examples, the receiving module 214 may determine that the gaze of the user 102 is detected in the second region 108B based at least in part on one or more parameters, as described above. The diagram 404 corresponding to Block 704 illustrates the gaze input 110 moving from in the first region 108A of the display 108 to the second region 108B of the display 108.

Block 706 illustrates updating content in the second region 108B of the display 108. Based at least in part on determining that the gaze of the user 102 moved from the first region 108A to the second region 108B, the updating module 216 may send updating data 302 and content 304 to the display module 212. The updating data 302 may direct the display module 212 to update content in the second region 108B of the display 108.

The content 304 may include content corresponding to a content item in the plurality of content items (e.g., the content item marked with an “x” in FIG. 7). In at least one example, the display module 212 may cause the content associated with the content item in first region 108A of the display 108 to be presented in the second region 108B of the display. The display module 212 may exploit change blindness so that the content 304 in the second region 108B of the display may be updated at a substantially same time as the user 102 moves his or her gaze from the first region 108A to the second region 108B (e.g., saccades from the first region 108A to the second region 108B). At the substantially same time as the user 102 moves his or her gaze from the first region 108A to the second region 108B, a period of blindness may occur such that the content in the second region 108 may be updated without causing the gaze of the user 102 to shift back to the first region 108A, shift to at least a third region of the display 108, or shift away from the display 108. The display module 212 may automatically present the content in the second region 108B with previously unseen content using one or more transitions, as described above.

The diagram 706 corresponding to Block 706 illustrates the gaze input 110 in the second region 108B of the display 108. Additionally, the diagram 706 illustrates the content associated with the content item in the first region 108A of the display is being presented in the second region 108B of the display 108. Accordingly, when the user 102 is ready to view the content associated with the content item in the first region 108A, the user 102 instinctively looks to the right of the display 108 into the second region 108B. When the user 102 looks to the right of the display 108, previously unseen content associated with the content item in the first region 108A may be presented and the user 102 may have little or no knowledge of the transition.

In a non-limiting example, the first region 108A of the display may include a plurality of email subject lines (e.g., emails listed in a user's 102 inbox). A user may look at a particular subject line corresponding to an email. When the user 102 moves his or her gaze into the second region of the display 108, the one or more tracking device(s) 106 may detect that the user's 102 gaze has moved from the first region 108A of the display 108 to the second region 108B of the display 108. Accordingly, the receiving module 214 may determine that the user's 102 gaze has moved from the first region 108A of the display 108 to the second region 108B of the display 108 and may send update data 302 and content 304 to the display module 212. The display module 212 may cause content associated with the particular subject line (e.g., the body of the email) to be presented in the second region 108B of the display 108 via one or more transitions and the user may have minimal knowledge of the transition.

In an additional non-limiting example, the first region 108A of the display may include the plurality of content items that may be representative of portions of a data file. For instance, the plurality of content items may include thumbnail images of pages of a document, thumbnail images that are representative of a portion of a data file, thumbnail images that are representative of a webpage, etc. A user may look at a particular data item of the plurality of data items (e.g., the content item marked with an “x” in FIG. 7). When the user 102 moves his or her gaze into the second region of the display 108, the one or more tracking device(s) 106 may detect that the user's 102 gaze has moved from the first region 108A of the display 108 to the second region 108B of the display 108. Accordingly, the receiving module 214 may determine that the user's 102 gaze has moved from the first region 108A of the display 108 to the second region 108B of the display 108 and may send update data 302 and content 304 to the display module 212. The display module 212 may cause content 304 associated with the particular data item to be presented in the second region 108B of the display 108 via one or more transitions and the user may have minimal knowledge of the transition. For instance, a user 102 may be viewing a page of a document in the second region 108B. The user 102 may be interested in viewing a page of a different document. The content item marked with an “x” in FIG. 7 may be a thumbnail image of the page from the different document. Accordingly, the user 102 may look at the content item marked with an “x” in FIG. 7 and then may look to the second region 108B. At a substantially same time as the user 102 looks from the first region 108A to the second region 108B, the display module 212 may cause content associated with the particular thumbnail image (e.g., the page of the different document) to be presented in the second region 108B of the display 108 via one or more transitions and the user may have minimal knowledge of the transition.

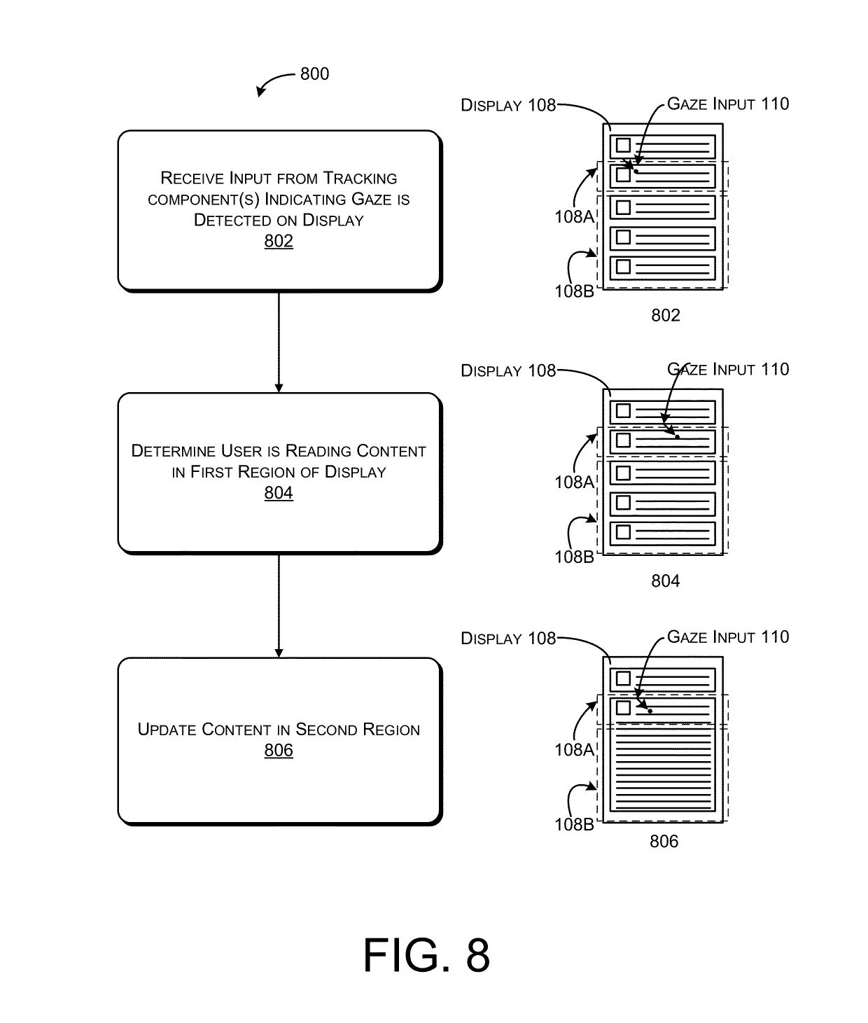

FIG. 8 illustrates an example process 800 for updating a portion of content presented on a display 108. Each block has a corresponding diagram shown to the right of the block.

Block 802 illustrates receiving input from one or more tracking component(s) 106 indicating a gaze of a user 102 is detected on a display 108, as described above. In the non-limiting example of FIG. 8, the diagram 802 corresponding to Block 802 illustrates the display 108 having a first region 108A illustrated by a dashed box around a particular content item and a second region 108B illustrated by a dashed box around a plurality of content items. The regions may include any number of content items and may be or equal or unequal size, as described above. The gaze input 110 in the first region 108A of the display 108 is associated with the particular content item in the first region 108A.

Block 804 illustrates determining, based at least in part on the gaze input 110, that the user 102 is reading and/or viewing content in the first region of the display 108A. In at least some examples, the system 104 may determine that the user is reading and/or viewing content in the first region of the display 108A based at least in part on one or more parameters (e.g., reading or viewing classifiers, dwell engines, etc.). The diagram 804 corresponding to Block 804 illustrates the gaze input 110 has moved within the first region 108A of the display 108 indicating that the user 102 is reading and/or viewing content in the first region of the display 108A.

Block 806 illustrates updating content in the second region 108B of the display 108. Based at least in part on determining that the user 102 is reading content in the first region 108A of the display 108, the updating module 216 may send updating data 302 and content 304 to the display module 212. The updating data 302 may direct the display module 212 to update content in the second region 108B of the display 108.

The content 304 may include content corresponding to the content item In at least one example, the display module 212 may cause the content represented by the content item in first region 108A of the display 108 to be presented in the second region 108B of the display. The display module 212 may exploit change blindness so that the content 304 in the second region 108B of the display may be updated while the user 102 is reading and/or viewing the content in the first region 108A of the display 108. Accordingly, the content in the second region 108 may be updated without causing the gaze of the user 102 to shift to the second region 108B, shift to at least a third region of the display 108, or shift away from the display 108. The display module 212 may automatically present the content in the second region 108B with previously unseen content using one or more transitions, as described above.

The diagram 806 corresponding to Block 806 illustrates the gaze input 110 in the second region 108B of the display 108. Additionally, the diagram 806 illustrates the content associated with the content item in the first region 108A of the display is being presented in the second region 108B of the display 108. Accordingly, when the user 102 is reading the content associated with the content item in the first region 108A, previously unseen content associated with the content item in the first region 108A may be presented and the user 102 in the second region 108B and the user 102 may have little or no knowledge of the transition.

In a non-limiting example, the display 108 may include a plurality of content items representing search results. The content items may include a thumbnail image, title, preview of text, etc., that is representative of a document, webpage, etc. The first region 108A of the display may include a one or more content items (e.g., individual search results). A user may look at content associated with the one or more content items (e.g., thumbnail image, title, preview of text, etc.). When the user 102 begins to read the title and/or short preview of text associated with the title, the one or more tracking device(s) 106 may detect that the user 102 is reading and/or viewing the content in the first region 108A of the display 108. In at least some examples, the system 104 may determine that the user 102 is reading and/or viewing the content based at least in part on one or more parameters (e.g., reading or viewing classifiers, dwell engines, etc.). Accordingly, the receiving module 214 may determine that the user 102 is reading and/or viewing content in the first region 108A of the display 108 and may send update data 302 and content 304 to the display module 212. The display module 212 may cause content associated with the particular content item (e.g., the document, webpage, etc., represented by the search result) to be presented in the second region 108B of the display 108 via one or more transitions and the user may have minimal knowledge of the transition.

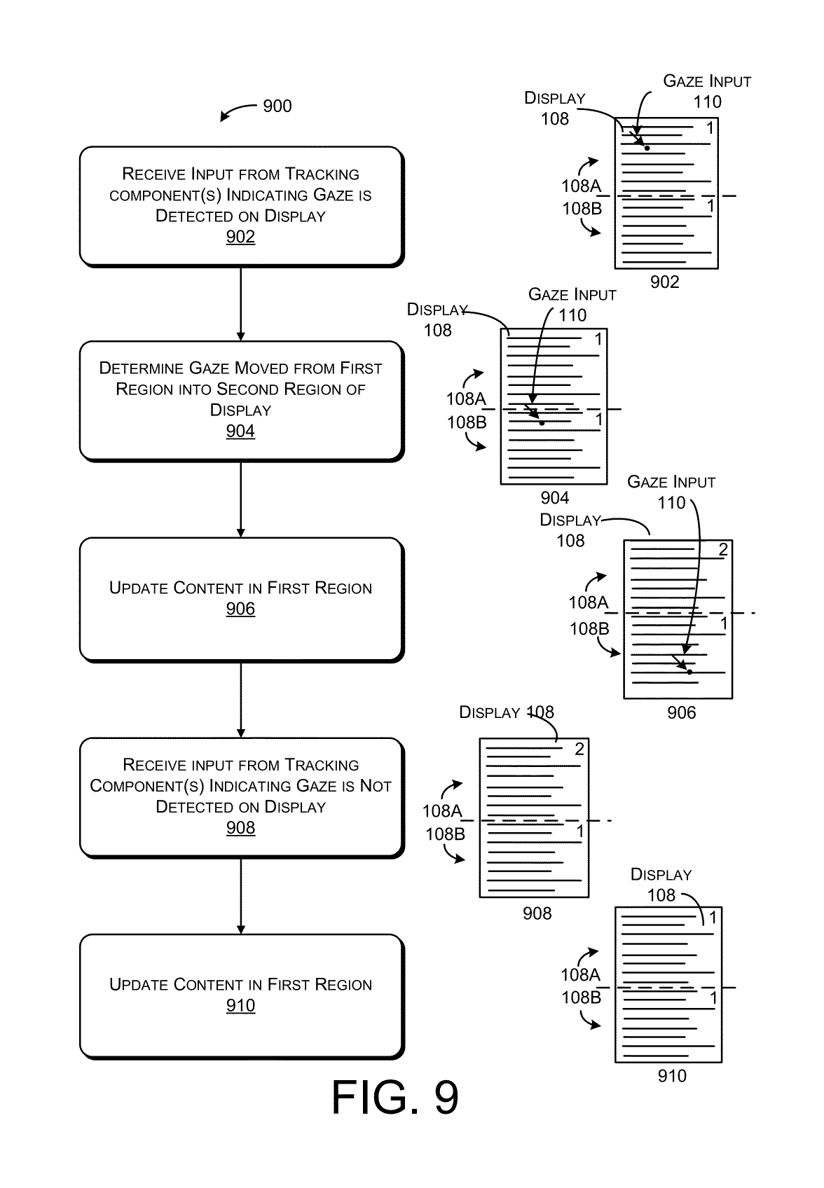

FIG. 9 illustrates an example process 900 for updating a portion of content presented on a display when a user 102 looks away from the display 108. Each block has a corresponding diagram shown to the right of the block.

Block 902 illustrates receiving input from one or more tracking component(s) 106 indicating that a gaze of a user 102 is detected on a display 108, as described above. The diagram 902 corresponding to Block 902 illustrates the gaze input 110 in the first region 108A of the display 108. In the non-limiting example of FIG. 9, the display 108 is presenting a first page of content, as indicated by the number “1” in the upper-right hand corner of the top region 108A and the bottom region 108B.

Block 904 illustrates determining that the gaze of the user 102 moved from a first region 108A of the at least two regions of the display 108 into a second region 108B of the at least two regions of the display 108. Based at least in part on the gaze input 110, the receiving module 214 may determine that a gaze of a user 102 moved from the first region 108A to the second region 108B of at least two regions of a display 108. In at least some examples, the receiving module 214 may determine that the gaze of the user 102 is in the second region 108B based at least in part on one or more parameters, as described above. The diagram 904 corresponding to Block 904 illustrates the gaze input 110 moving from in the first region 108A of the display 108 to the second region 108B of the display 108.

Block 906 illustrates updating a portion of the content in the first region 108A of the display 108. Based at least in part on determining that the gaze of the user 102 moved from the first region 108A to the second region 108B, the updating module 216 may send updating data 302 and content 304 to the display module 212. The updating data 302 may direct the display module 212 to update content in the first region 108A of the display 108 with previously unseen content, as described above. The diagram 906 corresponding to Block 906 illustrates the gaze input 110 in the second region 108B of the display 108. Additionally, the diagram 906 illustrates that the content previously associated with the first page of content, as indicated by the number “1” in the upper-right hand corner of the top region 108A, has been replaced with a previously unseen page of content, as indicated by the number “2” in the upper-right hand corner of the top region 108A. However, the bottom region 108B of the display 108 continues to display content associated with the first page of content, as indicated by the number “1” in the upper-right hand corner of the bottom region 108B. While the gaze of the user 102 is focused in the bottom region 108B of the display 108, the display module 212 caused previously unseen content to replace the content in the top region 108A of the display 108 without distracting the user 102. Accordingly, when the user 102 is ready to move on to viewing new content, the user 102 instinctively looks to the top of the display 108. When the user 102 looks to the top of the display 108, previously unseen content (e.g., new content) may be presented and the user 102 may have little or no knowledge of the transition.

Block 908 illustrates receiving input from the one or more tracking component(s) 108 indicating that the user 102 gaze is no longer detected on the display 108. In at least one example, the user 102 may set the user device 104 down and look away. In another example, the user 102 may stare out a window forgetting that he or she is interacting with the user device 102. The diagram 908 corresponding to Block 908 illustrates that gaze input 110 is not being detected on the display 108.

Block 910 illustrates updating content in the first region. To ensure the display 108 is presented in a consistent state when the user 102 returns to the display, the updating module 216 may send update data 302 and content 304 to the display module 212. The display module 212 may update all regions of the display (e.g., the first region 108A of the display) 108 with previously seen content so that when the user 102 returns to the display 108, the user 102 may begin reading or viewing the content in any position on the display 108A. The diagram 910 corresponding to Block 910 illustrates that the content associated with the second page of content (previously unseen), as indicated by the number “2” in the upper-right hand corner of the top region 108A, has been replaced with a previously seen portion of content, as indicated by the number “1” in the upper-right hand corner of the top region 108A. However, the bottom region 108B of the display 108 continues to display content associated with the first page of content, as indicated by the number “1” in the upper-right hand corner of the bottom region 108B. While the gaze of the user 102 left the display 108, the display module 212 caused previously seen content to replace the previously unseen content in the top region 108A of the display 108 without distracting the user 102. Accordingly, when the user 102 returns to the display 108, the user 102 may return to a display 108 representative of a same page of content and the user 102 may have no knowledge of the transition.

A. A system comprising: one or more tracking components; a display including at least two regions for presenting content; one or more processors; and computer-readable media storing one or more modules that are executable by the one or more processors to perform operations comprising: receiving input from the one or more tracking components, the input indicating that a gaze of a user is detected on a first region of the at least two regions of the display; determining that the gaze of the user has moved from the first region to a second region of the at least two regions of the display; and based at least in part on the determining that the gaze of the user moved from the first region to the second region, updating content in the first region of the display.

B. A system as paragraph A recites, wherein the content comprises at least one of text or images arranged in at least one of a left to right or a top to bottom progression on the display.

C. A system as any of paragraphs A or B recite, wherein the updating the content comprises replacing the content with previously unseen content using one or more transitions.

D. A system as paragraph C recites, wherein the one or more transitions comprise at least one of: cross-fading the content with the previously unseen content; morphing the content into the previously unseen content; or sweeping away the content and replacing the content with the previously unseen content.

E. A system as any of paragraphs A-D recite, wherein the updating the content comprises updating the content without causing the gaze of the user to at least one of shift back to the first region of the display, shift to a third region of the at least two regions of the display, or shift away from the display.

F. A system as any of paragraphs A-E recite, wherein the updating the content is based at least in part on detecting patterns in the input that indicate that the user is reading or viewing the content associated with the second region of the display.

G. A system as any of paragraphs A-F recite wherein the first region is a left region of the display and the second region is a right region of the display that is adjacent to the left region and is to the right of the left region.

H. A system as any of paragraphs A-G recite, wherein the first region is a top region of the display and the second region is a bottom region of the display that is adjacent to the top region and is below the top region.

I. A computer-implemented method comprising: receiving, from one or more tracking components, tracking data associated with user interaction on a display of a user device, the user interaction including at least one of a gaze of a user, a head position of the user, or a nose position of the user; determining, based at least in part on the tracking data, that the user interaction is associated with a region of the display; determining, based at least in part on the tracking data, that the user interaction has moved from the region of the display to a different region of the display; and modifying content associated with the region of the display while the user interaction is associated with the different region of the display.

J. A computer-implemented method as paragraph I recites, wherein the determining that the user interaction has moved from the region of the display to the different region of the display is based at least in part on at least one of reading classifiers for detecting patterns in the tracking data or determining that a user associated with the user device is reading the content in the different region of the display.

K. A computer-implemented method as any of paragraphs I or J recite, wherein the modifying the content associated with the region of the display comprises replacing the content with previously unseen content using one or more transitions.

L. A computer-implemented method as paragraph K recites, wherein the one or more transitions comprise at least one of: cross-fading the content with the previously unseen content; morphing the content into the previously unseen content; or sweeping away the content and replacing the content with the previously unseen content.

M. A computer-implemented method as any of paragraphs I-L recite, wherein the modifying the content associated with the region of the display comprises replacing the content with previously unseen content without causing the user interaction to at least one of shift back to the region of the display, shift to another region of the display that is not the region or the different region, or shift away from the display.

N. A computer-implemented method as paragraph M recites, wherein: the content comprises at least a portion of a page of an electronic book; and the previously unseen content comprises at least a portion of a subsequent page of the electronic book.

O. A computer-implemented method as paragraph M recites, wherein: the content comprises a first group of images of a plurality of images; and the previously unseen content comprises a second group of images of the plurality of images.

P. A computer-implemented method as any of paragraphs I-O recite, further comprising: determining, based at least in part on the tracking data, that the user interaction is not detected on the display; and replacing previously modified content associated with the region of the display with previously seen content.

Q. One or more computer-readable media encoded with instructions that, when executed by a processor, configure a computer to perform a method as any of paragraphs I-P recites.

R. A device comprising one or more processors and one or more computer readable media encoded with instructions that, when executed by the one or more processors, configure a computer to perform a computer-implemented method as recited in any one of paragraphs I-P.

S. A system comprising: means for receiving, from one or more tracking components, tracking data associated with user interaction on a display of a user device, the user interaction including at least one of a gaze of a user, a head position of the user, or a nose position of the user; means for determining, based at least in part on the tracking data, that the user interaction is associated with a region of the display; means for determining, based at least in part on the tracking data, that the user interaction has moved from the region of the display to a different region of the display; and means for modifying content associated with the region of the display while the user interaction is associated with the different region of the display.

T. A system as paragraph S recites, wherein the determining that the user interaction has moved from the region of the display to the different region of the display is based at least in part on at least one of reading classifiers for detecting patterns in the tracking data or determining that a user associated with the user device is reading the content in the different region of the display.

U. A system as any of paragraphs S or T recite, wherein the modifying the content associated with the region of the display comprises replacing the content with previously unseen content using one or more transitions.

V. A system as paragraph U recites, wherein the one or more transitions comprise at least one of: cross-fading the content with the previously unseen content; morphing the content into the previously unseen content; or sweeping away the content and replacing the content with the previously unseen content.

W. A system as any of paragraphs S-V recite, wherein the modifying the content associated with the region of the display comprises replacing the content with previously unseen content without causing the user interaction to at least one of shift back to the region of the display, shift to another region of the display that is not the region or the different region, or shift away from the display.

X. A system as paragraph W recites, wherein: the content comprises at least a portion of a page of an electronic book; and the previously unseen content comprises at least a portion of a subsequent page of the electronic book.

Y. A system as paragraph W recites, wherein: the content comprises a first group of images of a plurality of images; and the previously unseen content comprises a second group of images of the plurality of images.

Z. A system as any of paragraphs S-Y recite, further comprising: means for determining, based at least in part on the tracking data, that the user interaction is not detected on the display; and means for replacing previously modified content associated with the region of the display with previously seen content.

AA. One or more computer-readable media encoded with instructions that, when executed by a processor, perform acts comprising: determining, based at least in part on input from one or more tracking components, that a gaze of a user is associated with a region of a display; determining, based at least in part on the input, that the gaze of the user is associated with a different region of the display; and based at least in part on determining that the gaze of the user is associated with the different region and without causing the gaze of the user to at least one of shift back to the region of the display, shift to a new region of the display, or shift away from the display, replacing content associated with the region of the display with previously unseen content.

AB. One or more computer-readable media as paragraph AA recites, wherein the replacing the content associated with the region of the display comprises replacing the content with the previously unseen content using a cross-fade transition.

AC. One or more computer-readable media as any of paragraphs AA or AB recite, the acts further comprising: determining that the gaze of the user has moved from the different region of the display to another region of the display; and replacing content associated with the different region of the display with new previously unseen content without causing the gaze of the user to at least one of shift back to the different region of the display, shift to a new region of the display, or shift away from the display.

AD. One or more computer-readable media as any of paragraphs AA-AC recite, the acts further comprising: repeatedly determining that the gaze of a user is associated with at least one of the region of the display, the different region of the display, or another region of the display; and based at least in part on the repeatedly determining, replacing the content associated with one or more regions of the display that are not associated with the gaze of the user with previously unseen content.

AE. A device comprising one or more processors and one or more computer readable media as recited in any of paragraphs AA-AD.

### CONCLUSION

In closing, although the various examples have been described in language specific to structural features and/or methodical acts, it is to be understood that the subject matter defined in the appended representations is not necessarily limited to the specific features or acts described. Rather, the specific features and acts are disclosed as example forms of implementing the claimed subject matter.

What is claimed is:

1. A system comprising:
one or more tracking components;
a display including at least two regions for presenting content;
one or more processors; and
computer-readable media storing one or more modules that are executable by the one or more processors to perform operations comprising:
receiving input from the one or more tracking components, the input indicating that a gaze of a user is detected on a first region of the at least two regions of the display;
determining that the gaze of the user has moved from the first region to a second region of the at least two regions of the display; and
based at least in part on the determining that the gaze of the user moved from the first region to the second region, updating content in the first region of the display.

2. The system of claim 1, wherein the content comprises at least one of text or images arranged in at least one of a left to right or a top to bottom progression on the display.

3. The system of claim 1, wherein the updating the content comprises replacing the content with previously unseen content using one or more transitions.

4. The system of claim 4, wherein the one or more transitions comprise at least one of:
cross-fading the content with the previously unseen content;
morphing the content into the previously unseen content; or
sweeping away the content and replacing the content with the previously unseen content.

5. The system of claim 1, wherein the updating the content comprises updating the content without causing the gaze of the user to at least one of shift back to the first region of the display, shift to a third region of the at least two regions of the display, or shift away from the display.

6. The system of claim 1, wherein the updating the content is based at least in part on detecting patterns in the input that indicate that the user is reading or viewing the content associated with the second region of the display.

7. The system of claim 1, wherein the first region is a left region of the display and the second region is a right region of the display that is adjacent to the left region and is to the right of the left region.

8. The system of claim 1, wherein the first region is a top region of the display and the second region is a bottom region of the display that is adjacent to the top region and is below the top region.

9. A computer-implemented method comprising:
receiving, from one or more tracking components, tracking data associated with user interaction on a display of a user device, the user interaction including at least one of a gaze of a user, a head position of the user, or a nose position of the user;
determining, based at least in part on the tracking data, that the user interaction is associated with a region of the display;
determining, based at least in part on the tracking data, that the user interaction has moved from the region of the display to a different region of the display; and
modifying content associated with the region of the display while the user interaction is associated with the different region of the display.

10. The computer-implemented method of claim 9, wherein the determining that the user interaction has moved from the region of the display to the different region of the display is based at least in part on at least one of reading classifiers for detecting patterns in the tracking data or determining that a user associated with the user device is reading the content in the different region of the display.

11. The computer-implemented method of claim 9, wherein the modifying the content associated with the region of the display comprises replacing the content with previously unseen content using one or more transitions.

12. The computer-implemented method of claim 11, wherein the one or more transitions comprise at least one of:
cross-fading the content with the previously unseen content;
morphing the content into the previously unseen content; or
sweeping away the content and replacing the content with the previously unseen content.

13. The computer-implemented method of claim 9, wherein the modifying the content associated with the region of the display comprises replacing the content with previously unseen content without causing the user interaction to at least one of shift back to the region of the display, shift to another region of the display that is not the region or the different region, or shift away from the display.

14. The computer-implemented method of 13, wherein:
the content comprises at least a portion of a page of an electronic book; and
the previously unseen content comprises at least a portion of a subsequent page of the electronic book.

15. The computer-implemented method of claim 13, wherein:
the content comprises a first group of images of a plurality of images; and
the previously unseen content comprises a second group of images of the plurality of images.

16. The computer-implemented method of claim 9, further comprising:
determining, based at least in part on the tracking data, that the user interaction is not detected on the display; and
replacing previously modified content associated with the region of the display with previously seen content.

17. One or more computer-readable media encoded with instructions that, when executed by a processor, perform acts comprising:
determining, based at least in part on input from one or more tracking components, that a gaze of a user is associated with a region of a display;
determining, based at least in part on the input, that the gaze of the user is associated with a different region of the display; and
based at least in part on determining that the gaze of the user is associated with the different region and without causing the gaze of the user to at least one of shift back to the region of the display, shift to a new region of the display, or shift away from the display, replacing content associated with the region of the display with previously unseen content.

18. The one or more computer-readable media of claim 17, wherein the replacing the content associated with the region of the display comprises replacing the content with the previously unseen content using a cross-fade transition.

19. The one or more computer-readable media of claim 17, the acts further comprising:
determining that the gaze of the user has moved from the different region of the display to another region of the display; and
replacing content associated with the different region of the display with new previously unseen content without causing the gaze of the user to at least one of shift back to the different region of the display, shift to a new region of the display, or shift away from the display.

20. The one or more computer-readable media of claim 17, the acts further comprising:
repeatedly determining that the gaze of a user is associated with at least one of the region of the display, the different region of the display, or another region of the display; and
based at least in part on the repeatedly determining, replacing the content associated with one or more regions of the display that are not associated with the gaze of the user with previously unseen content.
